(19) United States
(12) Patent Application Publication
(10) Pub. No.: US 2013/0106138 A1
(43) Pub. Date: May 2, 2013

(54) METHOD FOR PRODUCING A MOTOR VEHICLE COMPONENT AND MOTOR VEHICLE COMPONENT

(71) Applicant: Benteler Automobiltechnik GmbH, Paderborn (DE)

(72) Inventors: Franz Ulrich Brockhoff, Bramsche (DE); Stefan Grottke, Rheine (DE); Stefan Schmitz, Bielefeld (DE); Holger Diersmann, Westerkappeln (DE)

(73) Assignee: Benteler Automobiltechnik GmbH, Paderborn (DE)

(21) Appl. No.: 13/659,451

(22) Filed: Oct. 24, 2012

(30) Foreign Application Priority Data
Oct. 28, 2011 (DE) 10 2011 054 909.9

(51) Int. Cl. B29C 70/02; B62D 29/00

(52) U.S. Cl. CPC B29C 70/028; B62D 29/001
USPC 296/187.03; 156/321

(57) ABSTRACT

A method for producing a motor vehicle hybrid component and motor vehicle hybrid component are disclosed, wherein the motor vehicle hybrid component has a base body produced from a metallic material which is then reinforced with a reinforcement patch made from a fiber composite material. A metallic layer is then applied onto the reinforcement patch. The metallic layer increases the strength of the component while maintaining an approximately identical specific component weight.

### CROSS-REFERENCES TO RELATED APPLICATIONS

This application claims the priority of German Patent Application, Serial No. 10 2011 054 909.9, filed Oct. 28, 2011, pursuant to 35 U.S.C. 119(a)-(d), the content of which is incorporated herein by reference in its entirety as if fully set forth herein.

### BACKGROUND OF THE INVENTION

The present invention relates to a to a method for producing a motor vehicle component and to a motor vehicle component made of a fiber composite material.

The following discussion of related art is provided to assist the reader in understanding the advantages of the invention, and is not to be construed as an admission that this related art is prior art to this invention.

Nowadays, the automobile industry has regulatory requirements as well as manufacturer requirements with the goal to produce motor vehicles with the lowest achievable fuel consumption. This limits, on one hand, handling of fossil fuels and has, on the other hand, less effect on the environment is because less fuel is burned.

Different approaches to save fuel exist in the state-of-the-art, for example the development of higher power internal combustion engines with improved efficiency.

Another concept is consequent use of light metal construction in all motor vehicle components and in the motor vehicle body itself. Different approaches here also exist which are known in the art, for example, to manufacture a motor vehicle body from high-strength or ultra-high-strength steels or from a light metal. This can result in potential weight savings of up to several ten kilograms in a self-supporting motor vehicle body.

Fiber composite components have also become of increasing interest for series-produced models due to consequent improvements in process automation for producing fiber composite components. The fiber materials use, for example, carbon fibers, glass fibers, basalt fibers, aramide fibers, steel fibers and similar fiber materials. A resin is applied to the fiber materials, which are then formed and hardened in a mold into the desired components or component parts. Components made from fiber composite materials have increased strength compared to comparable metallic components, while still having a lower specific intrinsic weight.

Due to their higher strength, the fiber composite material components are, unlike metallic components, initially more resistant in a vehicle crash and are thus better suited to absorb the crash energy. However, if individual fibers inside the fiber composite material were to break, then the crash properties abruptly decrease below those of comparable metallic components.

It would therefore be desirable and advantageous to obviate prior art shortcomings and to provide an improved method for producing a fiber composite material component which can be carried out very easily compared to conventional methods. It is also an object of the present invention to provide a component made from a fiber composite material which can be produced easily and cost-effectively and which has a smaller weight compared to conventional components made from a fiber composite material and/or has improved crash characteristics.

### SUMMARY OF THE INVENTION

According to one aspect of the present invention, a method for producing a motor vehicle hybrid component with a metallic base body and a reinforcement patch made from a fiber composite material includes the steps of producing the base body as a three-dimensionally shaped, hot-formed and press-hardened motor vehicle component, providing at least one layer of a fiber material, preferably providing two, in particular three or more layers of a fiber material which are stacked on top of one another, wherein the layers are pre-impregnated with resin and/or to which a resin is applied, inserting the fiber composite material stack into the motor vehicle component, forming the fiber composite material into the motor vehicle component for producing the motor vehicle hybrid component, wherein residual heat from the motor vehicle component is used for hardening the reinforcement patch or the motor vehicle component with the reinforcement patch is heated to cause the fiber composite material to harden, and at least partially applying a metallic layer on a fiber layer before and/or during and/or after forming, wherein the metallic layer is arranged on the side of the reinforcement patch facing the motor vehicle component.

According to another advantageous feature of the present invention, the metallic component in the motor vehicle hybrid component may be formed from a light metal alloy or from a steel alloy. For local reinforcement, the component may be constructed by applying the fiber material so as to produce a significant increase in strength while only slightly increasing its weight. The fiber composite material is hereby applied to the metallic motor vehicle component with the intention to reinforce the mostly supporting structure such that a first local failure occurs only at higher loads.

Due to the multilayer construction of the fiber composite material itself, buckling and/or bulging is delayed even more than with a simple patch made from a single-layer fiber composite material. However, to take advantage of the multilayer structure, for example in form of a sandwich structure, an additional metallic layer may advantageously be applied on the fiber composite material reinforcement in the region of the highest loads, without increasing the manufacturing complexity. The additional metallic layer may be applied before and/or during and/or after the fiber composite material is formed on the base body, i.e. the three-dimensional shaped motor vehicle component.

The metallic layer is initially cut to size commensurate with the loads, i.e. the metallic layer extends across the region having the highest stress concentrations, and is applied as a flat metal plate on the fiber composite material layers and/or the fiber composite material patch. The wall thickness of the metallic layer may advantageously be selected so as to yield and to be able to be formed with the shaping die and/or press die of the fiber composite material on the supporting structure of the motor vehicle component, in particular in the manufacturing process. In this way, the three-dimensional shape of both of the reinforcement patch and of the metallic layer is produced. In a subsequent hardening process of the fiber composite material, a material connection, in particular an adhesive connection, between the reinforcement patch and the metallic layer may be produced.

By applying the metallic layer on the reinforcement patch, the crash energy absorption capacity and/or strength characteristic of the motor vehicle hybrid component can be significantly increased without adding significant complexity in the manufacturing process. The manufacturing process may even be less complex compared to a complex sandwich structure of the reinforcement patch itself. The motor vehicle hybrid component can thus be produced more cost-effectively than with conventional manufacturing processes, while having a significantly higher strength with the same specific component weight.

According to another advantageous feature of the present invention, a metallic layer made from a light metal may be used. However, a metallic layer made of a metallic material may advantageously also be used. Furthermore, the metallic layer may be in form of a sheet metal blank.

According to another advantageous feature of the present invention, the metallic layer may be applied onto the fiber material layers of the reinforcement patch as a final layer. According to another advantageous feature of the present invention, the metallic layer is applied before or after the fiber material layers are formed on the motor vehicle component. Application of the metallic layer before the fiber material layers are formed has the particular advantage that the forming process itself causes excess resin to exit from the fiber material layer. The exiting resin may advantageously be used within the context of the invention to glue the metallic layer to the fiber composite material. During a following hardening process of the fiber composite material itself, the adhesive joint produced between the metallic layer and the fiber composite material then also hardens. The added complexity in the producing the motor vehicle hybrid component according to the invention is thus exclusively restricted to the additionally applied the metallic layer. This eliminates the complex production process associated with a multilayer sandwich structure.

According to another advantageous feature of the present invention, the metallic layer may also be covered by an additional fiber material layer. The resin exiting on both sides thereby ensures reliable cross-linking of the metallic layer with the fiber material layers surrounding the metallic layer. In addition, the additional fiber material layer covering the metallic layer provides corrosion protection, so that the strength of the motor vehicle hybrid component is not adversely affected even after many years of use.

According to another advantageous feature of the present invention, the metallic layer may advantageously be compressed with the fiber composite material. Moreover, the fiber composite material may advantageously be compressed with the motor vehicle component by way of the metallic layer. This ensures the formation of a homogeneous adhesive connection between the individual layers, thus eliminating the risk of a faulty adhesive connection while still maintaining a high manufacturing precision.

According to another advantageous feature of the present invention, the motor vehicle component itself may be produced as a hot-formed press-hardened component, wherein residual heat from the motor vehicle component may be used to harden the reinforcement patch, or the motor vehicle component with the reinforcement patch may be heated to allow the fiber composite material to harden. The reinforcement patch hardens fast with the introduction of heat. Advantageously, the metallic layer may also harden through introduction of heat. In this way, shorter hardening times are attained, thus preventing subsequent displacement, even when maintaining a short cycle time, during the manufacturing process.

According to another advantageous feature of the present invention, the reinforcement patch with the motor vehicle component may be initially produced and hardened. The metallic layer may then be glued onto the reinforcement patch. Depending on the application and complexity of the shape to be produced, additional adhesive may advantageously be applied between the metallic layer and the reinforcement patch. For example, a possible difference in height and/or unevenness may be compensated with the adhesive, so that a homogeneous joint between metallic layer and reinforcement patch can be produced.

According to another advantageous feature of the present invention, the metallic layer may additionally be treated with a corrosion protection, which ensures that the crash characteristics are not affected by corrosion on the metallic layer during the entire use of the motor vehicle component, i.e. during the life span of the motor vehicle.

Advantageously, a metallic layer with a wall thickness between 0.1 mm and 4 mm, more advantageously between 0.2 mm and 2.1 mm, may be used within the context of the invention. Metallic layers with a sheet metal thickness of 0.6 mm, 1.0 mm and/or 2.0 mm have proven to be particularly advantageous. The metallic layer is thus an optimal choice between three-dimensional shapeability, marginal increase of the specific inherent weight of the motor vehicle hybrid component and the corresponding maximal increase in the component strength.

The method according to the invention is used, in particular, to produce a motor vehicle column, in particular a B-column for a motor vehicle. The reinforcement patch is then advantageously inserted in the central and/or upper region of the motor vehicle B-column.

According to another aspect of the invention, a motor vehicle hybrid component is constructed from a metallic base body and a reinforcement patch made of a fiber composite material, wherein the motor vehicle hybrid component is produced with a aforedescribed method. A metallic layer is arranged inwardly with respect to a motor vehicle body on the reinforcement patch, wherein the energy absorption capability is increased with respect to conventional motor vehicle hybrid components by more than 5%, advantageously by more than 10%, and even by more than 15%. The metallic layer is arranged in a region of the motor vehicle component where the greatest load is produced in a crash.

Due to the metallic layer applied on the reinforcement patch according to the invention, the specific inherent weight of the motor vehicle hybrid component remains approximately unchanged, wherein the energy absorption capability, as expressed by the crash energy absorption capability and the stiffness of the component, is significantly increased. The metallic layer significantly delays tearing of the fibers of the reinforcement patch. According to another advantageous feature of the present invention, the reinforcement patch may be surrounded in the regions of high applied loads on two sides by a metallic layer structure.

This structure is, on one hand, the motor vehicle component itself and, on the other hand, the metallic layer. In this way, an upper layer, i.e. the outermost layer, of the reinforcement patch is initially prevented from tearing, which would cause the tear to continue to the layers of the fiber composite material disposed underneath. The metallic layers have a significantly higher elongation at break compared to the fiber composite layers, so that tearing of the fiber composite layers is delayed or even entirely prevented.

With respect to the motor vehicle body, the metallic layer is arranged inwardly on the motor vehicle hybrid component. On one hand, this produces design-related and aesthetic advantages, because the metallic layer cannot be seen by a driver or by onlookers. On the other hand, the metallic layer is prone to impact or pressure loads and scratches due to its sometimes very small thickness. By arranging the metallic layer on the inside, it is inaccessible to chemical influences, thereby preventing damage to the metallic layer.

According to another advantageous feature of the present invention, the metallic layer may be is disposed across the entire area in the fiber material layers. Within the context of the present invention, the entire component characteristic can thus be reinforced not only in the regions with local high loading and stress, but across the entire area. This also increases the specific component weight only marginally, while anti-proportionally increasing its strength.

According to another advantageous feature of the present invention, the metallic layer may also be arranged on both sides on the fiber composite material layers. In other words, within the context of the invention, a metallic layer may initially be arranged in the motor vehicle component, and thereafter a structure made of one or several fiber composite material layers may be placed, and lastly again a metallic layer may be placed. Advantageously, within the context of the invention, such structure in a motor vehicle component may selectively be made from a light metal, wherein the metallic layers are each formed from a steel material.

The metallic layer may be arranged on a region of the motor vehicle hybrid component where the highest local stresses can be expected in a crash. This prevents stress cracks within the reinforcement patch made of the fiber composite material.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 a cross-section through a motor vehicle hybrid component produced according to the present invention;

FIG. 2 a motor vehicle hybrid component produced according to the invention in an interior view;

FIGS. 3, 3b schematically a structure between reinforcement patch and metallic layer; and

FIG. 4 a force-distance diagram of a conventional motor vehicle hybrid component compared to a motor vehicle hybrid component produced according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

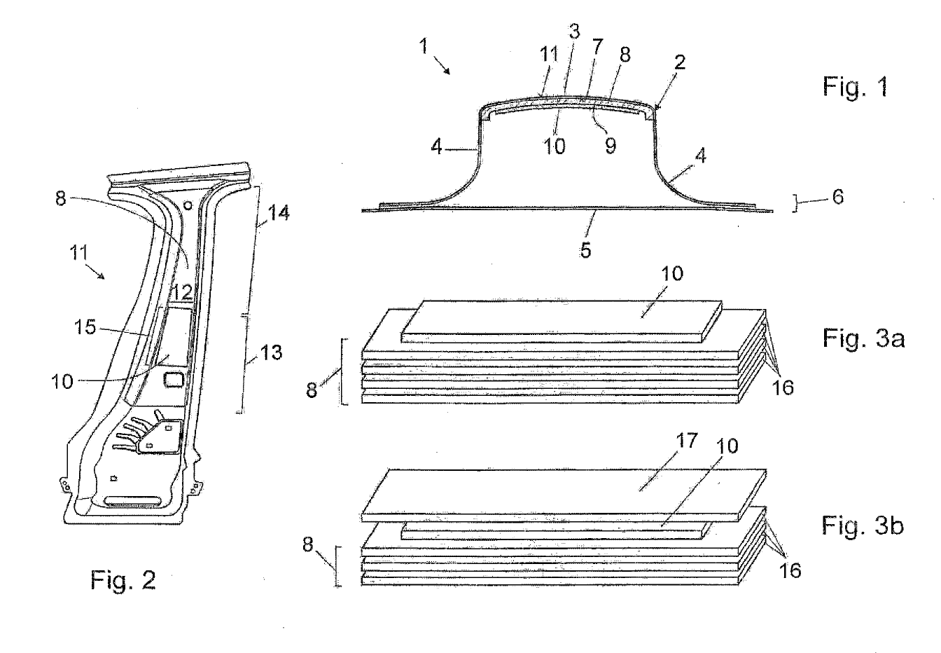

Turning now to the drawing, and in particular to FIG. 1, there is shown a motor vehicle hybrid component 1 according to the present invention in a cross-sectional view. The motor vehicle hybrid component 1 is shaped in form of a hat profile 2. The hat profile 2 is composed of a base web 3 with legs 4 abutting the base web 3. The motor vehicle hybrid component 1 is closed by a closure plate 5 disposed at the end of the hat profile 2. A reinforcement patch 8 made of several fiber composite material layers (not shown in detail) is arranged on an inner side 7 of the base web 3. Also arranged on an inner side 9 of the reinforcement patch 8 is a metallic layer 10 according to the invention. The reinforcement patch 8 is hence closed off at an outer side from the base web 3 of the motor vehicle hybrid component 1 and bordered at its inner side 7 by the metallic layer 10 as a sandwich component.

FIG. 2 shows the motor vehicle hybrid component 1 according to the present invention in form of a B-column. The reinforcement patch 8 is arranged in the interior space 12 of the B-column 11, with the B-column 11 having in cross-section a substantially hat-shaped profile. The reinforcement patch 8 is hereby arranged in a central region 13 and in an upper region 14 of the B-column 11. The metallic layer 10 is once more only applied in a section of the central region 13. Locally high stress loading is expected in this section, in particular in a crash of the motor vehicle.

FIGS. 3a and 3b each show schematically a structure of a reinforcement patch 8 with the metallic layer 10 according to the present invention. FIG. 3a shows the reinforcement patch 8 with four fiber material layers 16 and a final metallic layer 10. FIG. 3b shows the actual reinforcement patch 8 according to the invention with three bottom fiber material layers 16 and a metallic layer 10 disposed on top. In addition, a topmost fiber material layer 17 is formed thereon or applied on the metallic layer 10, providing additional reinforcement and additional corrosion protection. The individual fiber material layers 16 are coupled with one another by way of a resin (not shown in detail). Any gaps in the figures are only shown for illustrative purposes.

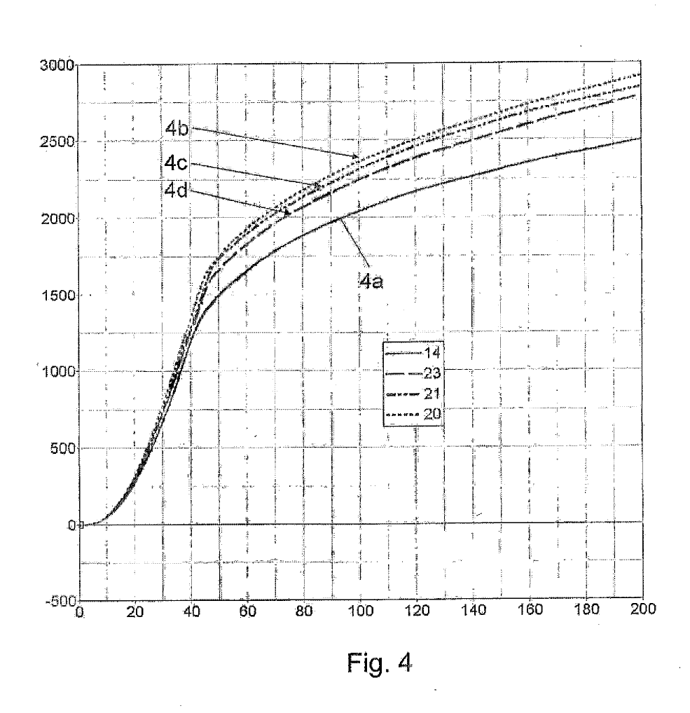

FIG. 4 shows a force-elongation diagram, wherein a force applied to the component is shown on the abscissa and a corresponding deformation distance is shown on the ordinate. The curve 4a hereby represents a conventional motor vehicle hybrid component 1 made of a metallic base body and a reinforcement patch 8 made of fiber composite material connected thereto. The curves 4b to 4d conversely show the application of an additional metallic layer 10 on the reinforcement patch 8, wherein the second metallic layer 10 has a wall thickness of 2 mm in curve 4b, a wall thickness of 1 mm in a curve 4c, and a wall thickness of 0.6 mm in curve 4d. The strength of the component is already increased by 10% compared to a conventionally produced motor vehicle hybrid component 1 shown in curve 4a even when a metallic layer 10 having a wall thickness of only 0.6 mm is applied.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for producing a motor vehicle hybrid component with a metallic base body and a reinforcement patch made from a fiber composite material, the method comprising the steps of:
producing the base body as a three-dimensionally shaped, hot-formed and press-hardened motor vehicle component,
providing at least one layer of a fiber material, said at least one layer having a pre-impregnated or applied resin and forming a reinforcement patch,
inserting the at least one layer of the fiber composite material into the motor vehicle component,
forming the at least one layer of the fiber composite material onto the motor vehicle component,
hardening the reinforcement patch with residual heat from the motor vehicle component or by heating the motor vehicle component together with the reinforcement patch, and
at least partially applying a metallic layer to a layer of the fiber composite material that faces away from the motor vehicle component, before, during or after forming, thereby producing the motor vehicle hybrid component.

2. The method of claim 1, wherein two, three or more layers of the fiber material are stacked on top of one another.

3. The method of claim 1, wherein the metallic layer made from a light metal.

4. The method of claim 1, wherein the metallic layer is applied on the at least one layer of the fiber composite material as a final layer.

5. The method of claim 4, wherein the metallic layer is applied before or after the fiber material layers are formed onto the motor vehicle component.

6. The method of claim 4, wherein the metallic layer is glued together with the excess resin exiting from the fiber composite material during the forming process.

7. The method of claim 1, wherein the metallic layer is covered with an additional fiber material layer.

8. The method of claim 1, wherein the metallic layer is compressed with the fiber composite material.

9. The method of claim 1, wherein the metallic layer is pretreated.

10. The method of claim 9, wherein the metallic layer is pretreated with a primer or by roughening a surface of the metallic layer, or both.

11. The method of claim 1, wherein the reinforcement patch with the motor vehicle component is produced first and hardened, and the metallic layer is subsequently glued onto the reinforcement patch.

12. The method of claim 1, wherein the metallic layer is treated with a corrosion protection.

13. The method of claim 1, wherein the metallic layer has a wall thickness between 0.1 mm and 4.0 mm.

14. The method of claim 1, wherein the metallic layer has a wall thickness between 0.2 mm and 2.1 mm.

15. A motor vehicle hybrid component comprising:
a metallic base body,
a reinforcement patch made from at least one layer of a fiber composite material and having two sides, with a first side of the reinforcement patch facing the metallic base body,
a metallic layer disposed on a second side of the reinforcement patch facing away from the metallic base body,
wherein an energy absorption capability of the motor vehicle hybrid component is increased by at least 15% compared to an energy absorption capability of a conventional motor vehicle hybrid component, and
wherein the metallic layer is arranged on a region of the motor vehicle component that experiences highest loading in a crash.

16. The motor vehicle hybrid component of claim 15, wherein an energy absorption capability is increased by at least 5%.

17. The motor vehicle hybrid component of claim 15, wherein an energy absorption capability is increased by at least 10%.

18. The motor vehicle hybrid component of claim 15, wherein the metallic layer is arranged across an entire surface on the at least one layer of the fiber composite material.

19. The motor vehicle hybrid component of claim 15, wherein a metallic layer is arranged on both the first side and the second side of the at least one layer of the fiber composite material.

20. The motor vehicle hybrid component of claim 15, wherein the base body comprises a three-dimensionally shaped, hot-formed and press-hardened motor vehicle component.

21. The motor vehicle hybrid component of claim 15, wherein the at least one layer comprises a pre-impregnated or applied resin.
